(19) United States
(12) Patent Application Publication
(10) Pub. No.: US 2018/0307535 A1
(43) Pub. Date: Oct. 25, 2018

(54) COMPUTER SYSTEM AND METHOD FOR CONTROLLING COMPUTER

(71) Applicant: HITACHI, LTD., Tokyo (JP)

(72) Inventors: Akifumi SUZUKI, Tokyo (JP); Mitsuhiro OKADA, Tokyo (JP)

(21) Appl. No.: 15/763,224

(22) PCT Filed: Jan. 7, 2016
(86) PCT No.: PCT/JP2016/050336

§ 371 Date: Mar. 26, 2018

(51) Int. Cl. G06F 9/50; G06F 3/06

(52) U.S. Cl. CPC G06F 9/505; G06F 3/0659; G06F 3/0683; G06F 3/061; G06F 9/5016

(57) ABSTRACT

A computer system operates a data processing unit that includes a first memory, an accelerator including a second memory, and a storage device. The computer system receives a processing request for data and analyzes the contents of processing included in the processing request and detects a load of the accelerator. An off-load processing unit acquires the analysis results and the load of the accelerator to make the accelerator execute the processing when a predetermined condition is established. The processor executes the received processing when the predetermined condition is not established. The off-load processing unit makes the accelerator secure a storage area in the second memory, makes the storage device transmit the data, and the accelerator executes the processing. The processing execution unit makes the processor secure a storage area in the first memory, makes the storage device transmit the data, and the processor executes the processing.

### TECHNICAL FIELD

The present invention relates to a computer system that performs data processing, and an accelerator connected to the computer system.

### BACKGROUND ART

A computer system is intended for any data processing. The data processing is performed by a processor within the computer system. In addition, data to be processed is stored in a secondary storage device (for example, a Hard Disk Drive (HDD)) or the like of the computer system, and the processor instructs the secondary storage device to transmit the data to be processed to a primary storage device (for example, a Dynamic Random Access Memory (DRAM)). The processor processes the data stored in the primary storage device after data transmission by the secondary storage device is completed. In such a computer system, the transmission performance of the secondary storage device becomes a bottleneck, and thus the performance of the data processing is restricted.

In recent years, a computer system using a Solid State Drive (SSD) as a secondary storage device has become widespread. The SSD is used as the secondary storage device, the transmission performance of data is rapidly improved, and the above-mentioned bottleneck due to the secondary storage device is solved. However, the performance of the secondary storage device is improved, while an improvement in the performance of a processor performing data processing is slowed, and thus the processing performance of the processor in a data processing system becomes a bottleneck of the entire computer system.

In order to avoid the bottleneck of data processing performance due to the processor, a computer system connected to a device such as a Field-Programmable Gate Array (FPGA) or a Graphics Processing Unit (GPU) and taking charge of a portion of data processing instead of a processor has appeared (for example, PTL 1).

### CITATION LIST

### Patent Literature

PTL 1: U.S. Pat. No. 8,824,492

### SUMMARY OF INVENTION

### Technical Problem

PTL 1 described above discloses a technique for directly transmitting data to the FPGA serving as an accelerator from the secondary storage device, performing predetermined processing by the FPGA, and then transmitting processing results to a primary storage device.

However, various data processing also includes processing in which it is effective to perform processing by a processor rather than perform off-loading to an accelerator. For example, in a case where the size of data which is a target for off-load processing is small, the processor needs to perform a process of performing control for transmitting a small amount of data to the accelerator, performing control for transmitting information having off-load processing contents described therein to the accelerator, and acquiring results of the off-load processing which are notified from the accelerator.

In this manner, in a case where the size of data is small, a new processing load occurs in order to off-load processing to the accelerator even when the load of the data processing to the processor is reduced. Accordingly, the off-load from the processor to the accelerator is not sufficiently performed, which may result in a problem that a performance bottleneck of the processor is not avoided.

In the technique disclosed in PTL 1 described above, all processing is off-loaded to the accelerator without consideration of such a problem, and thus an appropriate performance improving effect may not be obtained as described.

In a configuration in which a plurality of analysis processing are all off-loaded to an accelerator as in PTL 1 described above, the accelerator needs to be equipped with all analysis processing. In such a configuration, it is necessary to develop the accelerator in consideration of even processing which occurs extremely rarely, and there is a problem in that the number of development processes and costs are increased.

In the technique disclosed in PTL 1 described above, all processing is off-loaded to the accelerator without consideration of such a problem, and thus the accelerator needs to be equipped with all data processing likely to be executed by the computer system.

In a computer system in which a plurality of applications are operated and a plurality of accelerators connected thereto are operated, various applications individually use the accelerators. In this case, it is necessary to level processing loads of the accelerators, but there is a problem in that it is not possible to level the load of the accelerator in PTL 1 described above.

### Solution to Problem

According to the invention, there is provided a computer system that operates a data processing unit, the computer system including a processor, a first memory which is connected to the processor, an accelerator which includes a second memory, and a storage device which is connected to the processor and the accelerator to store data, in which the data processing unit includes a processing request reception unit which receives a processing request for the data, a processing content analysis unit which analyzes contents of processing included in the processing request, a load detection unit which detects a load of the accelerator, an off-load processing unit which acquires analysis results of the contents of the processing and the load of the accelerator to make the accelerator execute the received processing when a predetermined condition is established, and a processing execution unit which makes the processor execute the received processing when the predetermined condition is not established, in which the off-load processing unit makes the accelerator secure a storage area in the second memory, makes the storage device transmit the data included in the processing request to the storage area of the second memory, and makes the accelerator execute the processing, and in which the processing execution unit makes the processor secure a storage area in the first memory, makes the storage device transmit the data included in the processing request to the storage area of the first memory, and makes the processor execute the processing.

### Advantageous Effects of Invention

According to the invention, in a computer system performing various data processing, it is possible to off-load only processing capable of being off-loaded to an accelerator. For example, in all data processing of the computer system, processing contents generated at a high frequency are processed by the accelerator at high speed, and thus it is possible to improve the overall performance of the computer system. In addition, it is possible to level loads of a plurality of accelerators and to improve the overall data processing performance of the computer system.

### BRIEF DESCRIPTION OF DRAWINGS

FIG. 1 illustrates an example of the invention, and is a block diagram illustrating an example of a computer system.

FIG. 2 illustrates an example of the invention, and is a block diagram illustrating an example of an accelerator.

FIG. 3 illustrates an example of the invention, and is a block diagram illustrating an example of a data transmission path in a server.

FIG. 4 illustrates an example of the invention, and is a block diagram illustrating an example of a software configuration of the server.

FIG. 5 illustrates an example of the invention, and is a flowchart illustrating an example of processing performed in the server.

FIG. 6 illustrates an example of the invention, and is a diagram illustrating an example of accelerator management information of the server.

FIG. 7 illustrates an example of the invention, and is a map illustrating an example of a memory space of the server.

FIG. 8 illustrates a modification example of the invention, and is a block diagram illustrating an example of the computer system.

FIG. 9 illustrates a modification example of the invention, and is a block diagram illustrating an example of the computer system.

FIG. 10 illustrates a modification example of the invention, and is a block diagram illustrating an example of a software configuration of the server.

### DESCRIPTION OF EMBODIMENTS

Hereinafter, an example of the invention will be described with reference to the accompanying drawings.

### EXAMPLE 1

(1-1) System Configuration

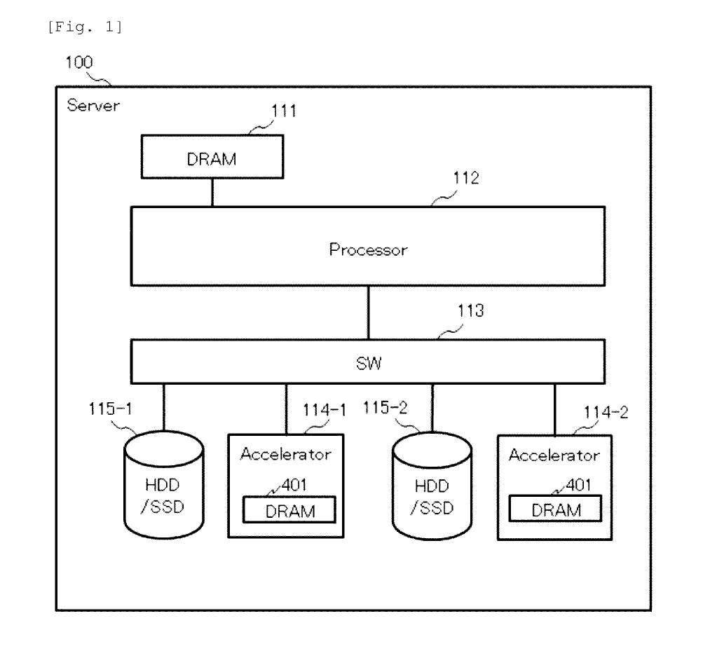

FIG. 1 is a block diagram illustrating an example of a computer system. First, a configuration of the computer system to which the invention is applied will be described with reference to FIG. 1. FIG. 1 illustrates an example of the computer system to which the invention is applied, and the invention can be applied to a computer system with FIG. 1 as an example. First, FIG. 1 will be described.

FIG. 1 illustrates a configuration of a server 100 to which the invention is applied. The server 100 in FIG. 1 includes a DRAM 111 which is a primary storage area (or a main storage device, a memory), a processor 112 that performs various processing in accordance with software, a switch (hereinafter, a SW) 113 for connecting various peripheral devices to each other, an HDD/SSD 115-1 and an HDD/SSD 115-2 serving as secondary storage areas (or auxiliary storage devices, storage devices), and accelerators 114-1 and 114-2 that perform data processing on the basis of an instruction given from the processor 112. Meanwhile, the entire accelerator is denoted by reference numeral 114 without “-”. The other components are similarly denoted by reference numerals without “-” to indicate the entire components.

The DRAM 111 is connected so as to be accessible from the processor 112 in a short period of time, and is a storage area that stores programs to be processed by the processor 112 and data to be processed.

The processor 112 is a device which is operated in accordance with a program and processes target data. The processor 112 includes a plurality of processor cores (not shown) therein, and the processor cores can independently process a program. In addition, the processor 112 includes a DRAM controller therein, and acquires data from the DRAM 111 in response to a request given from the processor core or stores data in the DRAM 111.

In addition, the processor 112 including external IO software (not shown) is connected to the SW 113. In addition, the processor 112 can give an instruction to the HDD/SSD 115 which is a secondary storage device and the accelerator 114 through the SW 113.

The SW 113 is a component for relaying a high-speed external IO bus, and transmits a packet having a connection standard, such as PCI-Express or Infiniband, by a predetermined routing system. The SW 113 connects a plurality of HDD/SSDs 115 and accelerators 114 to each other, and transmits information between the processor 112 and various devices.

The HDD/SSD 115 is a secondary storage device that stores data to be processed. In the invention, the HDD/SSD 115 transmits target data to the DARM 111 or a DRAM (main storage device) 401 to be described later within the accelerator 114 on the basis of information notified from the processor 112. In the invention, the secondary storage device may be either an HDD or an SSD.

Meanwhile, in FIG. 1 illustrating a configuration of the server 100 of this example, an example in which connection to the HDD/SSD 115 through the SW 113 provided outside the processor 112 is described. However, the invention is not limited to this example, and the processor 112 may be directly connected to the HDD/SSD 115 and the accelerator 114.

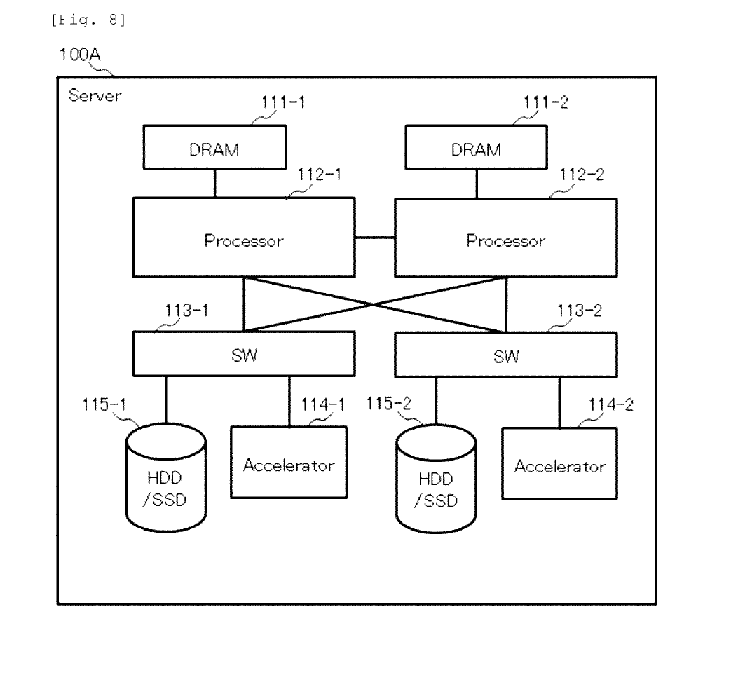

In FIG. 1 illustrating a configuration of the server of this example, a configuration in which the server 100 includes one processor 112 and one SW 113 is described, but the invention is not limited to this example. For example, as illustrated in FIG. 7, a server 100A may be equipped with a plurality of processors 112-1 and 112-2 and SWs 113-1 and 113-2, or a configuration in which a plurality of SWs 113 are connected to one processor 112 or a configuration in which one SW 113 is connected to a plurality of processors 112 may be adopted.

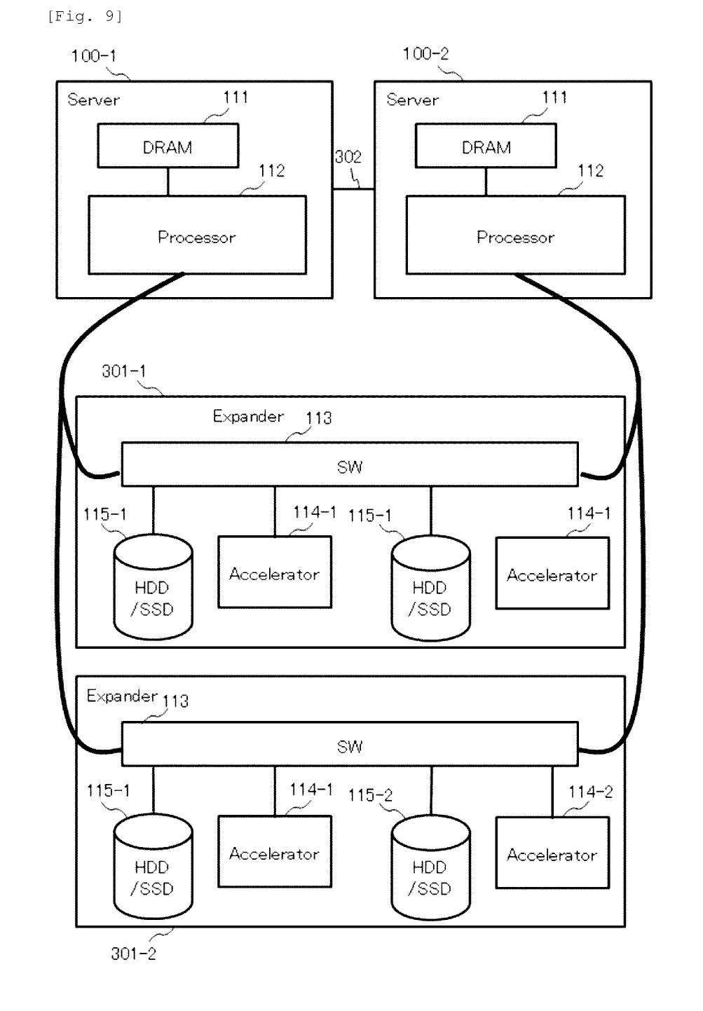

In FIG. 1 illustrating a configuration of the server of this example, a configuration in which the server 100 includes the SW 113 is described, but the invention is not limited to this configuration. For example, as illustrated in FIG. 8, a configuration may be adopted in which a plurality of servers 100-1 and 100-2 are provided and a plurality of servers 100 share a plurality of expanders 301-1 and 301-2.

The expander 301 includes the SW 113, the HDD/SSD 115-1 and the HDD/SSD 115-2, and the accelerators 114-1 and 114-2, and the HDD/SSD 115 and the accelerator 114 are connected to the processor 112 within the server 100 through the SW 113.

In the above-described configuration, the servers 100-1 and 100-2 communicate with each other by using a communication path 302 (for example, Infiniband or Ethernet) between the servers, and performs management of a DRAM region within the accelerator 114 to be described later in cooperation with each other.

(1-2) Configuration of Accelerator

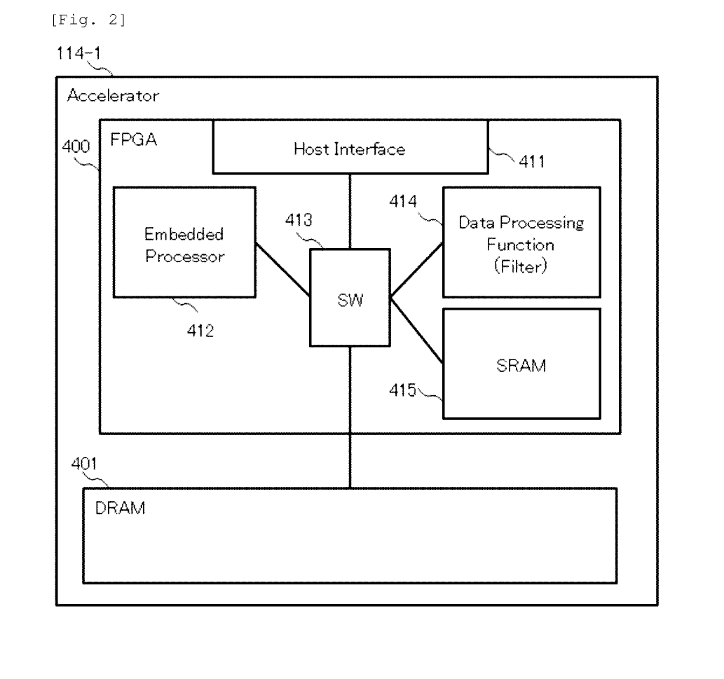

Next, an internal configuration of the accelerator 114-1 to which the invention is applied will be described with reference to FIG. 2. FIG. 2 is a block diagram illustrating an example of the accelerator 114-1. The accelerator 114-1 illustrated in FIG. 2 is constituted by an FPGA 400 and a DRAM 401. Meanwhile, the accelerators 114-1 and 114-2 illustrated in FIG. 1 have the same configuration.

The FPGA 400 includes at least a host interface unit 411, an integrated processor 412, an FPGA internal switch unit 413, a data processing functional unit 414, and an SRAM unit 415 therein.

The host interface unit 411 is a function provided in the FPGA 400, and is a functional unit that performs data communication with the SW 113 connected thereto.

The integrated processor 412 is a functional unit that performs predetermined processing on the basis of an instruction given from a host (processor 112). In this example, the processor 112 within the server 100 creates an off-load command of filtering processing (processing for extracting only data matching designated conditions in target data) with respect to the accelerator 114, and instructs the accelerator 114 to perform the off-load command.

When the integrated processor 412 detects this instruction, the integrated processor acquires a command from the server 100. The integrated processor 412 acquires conditions of the filtering processing, and notifies the data processing functional unit 414 to be described later of the conditions. Next, the data processing functional unit 414 is notified of the position of target data in the DRAM 401 within the accelerator 114 and is instructed to start processing.

The FPGA internal switch unit 413 is connected to each functional unit within the FPGA 400 to perform information communication with the functional unit. In addition, FIG. 2 illustrates an example of the switch connected in the form of a star, but the FPGA internal switch unit 413 may be connected by a shared bus configuration.

The data processing functional unit 414 is a logic circuit that performs data processing on the basis of contents instructed from the processor 112 of the server. The data processing functional unit 414 starts processing on the basis of an instruction of the integrated processor 412, reads out target data from the region of the DRAM 401 within the accelerator 114 which is designated from the integrated processor 412, and transmits only data corresponding to conditions in the target data to the processor 112 of the server 100 through the host interface unit 411 by using filtering conditions instructed from the integrated processor 412.

In this example, filtering processing is described as an example of data processing, but the invention is not limited to the data processing contents. For example, addition processing may be performed, or control for computationally calculating a total value of designated data and transmitting only the total value to the server 100 may be performed.

In this example, the accelerator 114 is constituted by an FPGA, but the invention is not limited to this example. For example, the accelerator 114 may be constituted by a GPU, and various processing may be all processed by a core of the GPU irrespective of the data processing functional unit 414, the integrated processor 412, and the like.

(1-3) Data Transmission Path in Case of Being Processed by Accelerator

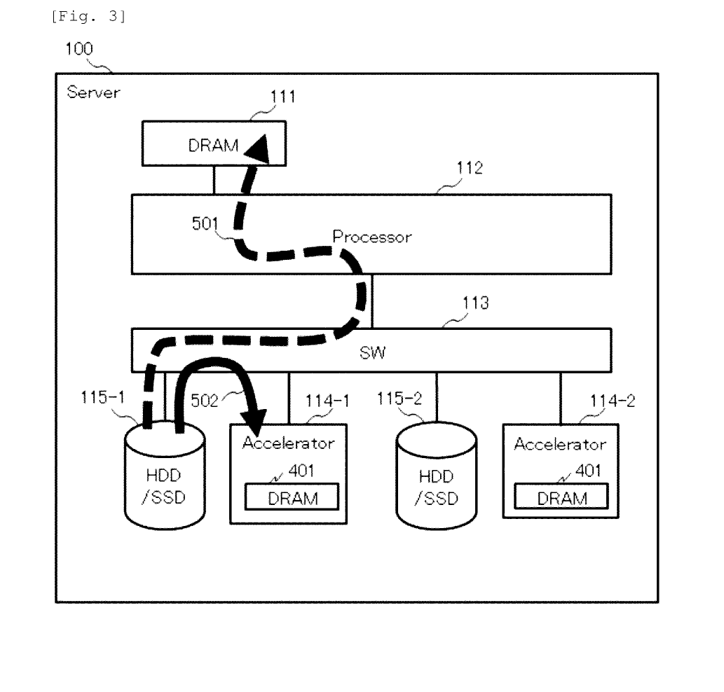

Subsequently, a data transmission path in this example will be described with reference to FIG. 3. In this example, it is determined whether data processing is performed by the processor 112 itself within the server 100 on the basis of data processing contents or is off-loaded to the accelerator 114. In this example, as an example, the processor 112 itself performs filtering processing in a case where the size of target data to be subjected to the filtering processing is small (equal to or less than a threshold value Th1), and processing is performed by the data processing functional unit 414 within the accelerator 114 in a case where the size of target data to be subjected to the filtering processing is large (greater than the threshold value Th1).

A data transmission path 501 indicated by an arrow of a dotted line in FIG. 3 is a data transmission path when data processing is performed by the processor 112 itself. The processor 112 secures a region within the DRAM 111 by using a standard function of an operating system as a region for storing target data, and notifies the HDD/SSD 115 of the region. The HDD/SSD 115 having received the notification transmits the target data toward the region within the DRAM 111. After the transmission of the target data is completed, the HDD/SSD 115 notifies the processor 112 that the data transmission has been completed.

After the processor 112 acquires the notification indicating the completion of data transmission, the processor directly accesses the DRAM 111 to acquire target data and perform filtering processing.

On the other hand, a data transmission path 502 indicated by an arrow of a solid line in FIG. 3 is a data transmission path when data processing is off-loaded to the accelerator 114. The processor 112 secures a storage area in the DRAM 401 within the accelerator 114 by using an accelerator DRAM allocator 621 to be described later as a region for storing target data, and notifies the HDD/SSD 115 of the storage area. The HDD/SSD 115 having received the notification transmits the target data toward the region of the DRAM 401 within the accelerator 114. After the transmission of the target data is completed, the HDD/SSD notifies the processor 112 that the transmission of the target data has been completed.

After the processor 112 is notified that the data transmission has been completed, the processor creates a command for off-load. The command for off-load includes conditions of filtering processing, and the like. The processor 112 notifies the accelerator 114 of the command. The integrated processor 412 within the accelerator notified of the command notifies the data processing functional unit 414 of the conditions of filtering processing notified from the processor 112. Thereafter, the integrated processor 412 instructs the data processing functional unit 414 to start processing.

The data processing functional unit 414 having received the instruction from the integrated processor 412 acquires target data from the DRAM 401 to perform filtering processing. The integrated processor 412 transmits results of the filtering processing to the processor 112 of the server 100.

As described above, the data transmission path 502 indicated by a solid line in FIG. 3 when performing data processing by the accelerator 114 is realized, and thus it is possible to realize the data processing by only transmitting target data to only a path between the HDD/SSD 115 and the accelerator 114 without transmitting target data to a data transmission path, having a transmission load concentrated thereon, between the processor 112 and the SW 113 and a transmission path between the processor 112 and the DRAM 111.

Therefore, it is possible to achieve an improvement in performance by only increasing the number of HDD/SSDs 115 and the number of accelerators 114 without reinforcing the processor 112 and the DRAM 111 when improving the performance of the server 100.

(1-4) Software Configuration

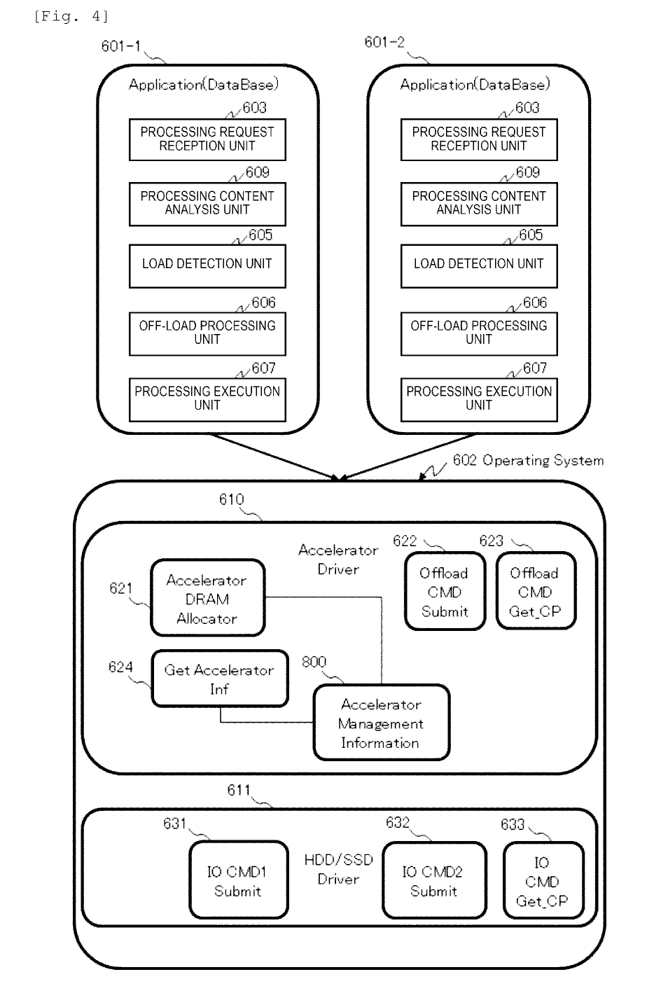

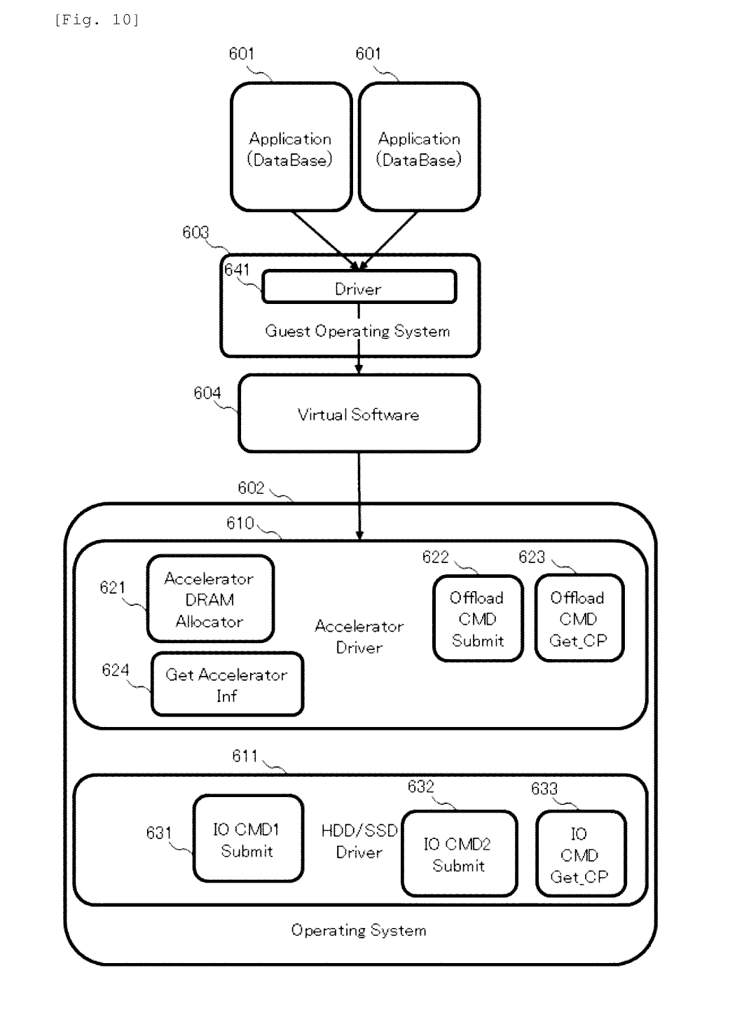

Subsequently, a software configuration in Example 1 will be described with reference to FIG. 4. FIG. 4 is a block diagram illustrating an example of a configuration of software of the server 100 in this example. Any software illustrated in FIG. 4 is processed by the processor 112 of the server 100 illustrated in FIG. 1, or the server 100A, 100-1, or 100-2 illustrated in FIG. 8 or 9.

Applications 601-1 and 601-2 are database software for performing data processing which is stored in, for example, the HDD/SSD 115, and are software operated on a virtual (or logical) address provided by an operating system 602. Meanwhile, in this example, database software is exemplified as an example of an application for performing data processing, and an example is described in which the database software performs filtering processing and index management information generation processing. However, the invention is not limited to the software. For example, the application may be image processing software, and the invention may be applied to image processing software that off-loads image processing (for example, image format conversion) to the accelerator.

In addition, as illustrated in FIG. 4, the application 601 is not limited to an application operated on the operating system 602.

For example, like the application 601 illustrated in FIG. 10, the invention is also applied to an application operated on the guest operating system 602 which is managed by virtualization software 604 operated on the operating system 602.

In FIG. 4, the application 601 functioning as a data processing unit includes a processing request reception unit 603 that receives a data processing request, a processing content analysis unit 609 that analyzes received processing content, a load detection unit 605 that detects the load of the accelerator 114, an off-load processing unit 606 that determines whether or not the off-load of processing is performed and executes off-load processing, and a processing execution unit 607 that executes data processing by the processor 112 in a case where the off-load of processing is not performed.

The processing content analysis unit 609 of the application 601 acquires in advance or sets processing capable of being off-loaded to the accelerator 114, and determines whether to process various processing occurring therein by the accelerator or the processor 112.

In addition, the load detection unit 605 of the application 601 acquires accelerator management information 800 to be described later from an accelerator driver 610 to acquire load conditions of the accelerator 114. In a case where it is determined that the load of the accelerator 114 is equal to or greater than a predetermined threshold value Th2 which is high and that processing by the processor 112 can be performed at higher speed, the off-load processing unit 606 of the application 601 prohibits the off-load to the accelerator 114 even when the off-load to the accelerator 114 can be performed as a processing content, so that the processing execution unit 607 performs processing by the processor 112.

In addition, the off-load processing unit 606 acquires loads of the plurality of accelerators 114 from the accelerator management information 800 to be described later in a case where processing is off-loaded to the accelerator 114, and selects the accelerator 114 having a relatively low load to off-load processing. For example, the application 601 selects the accelerator 114 having a minimum load among the plurality of accelerators 114 to off-load processing.

The operating system 602 is software that manages the accelerator 114, the HDD/SSD 115 which is a secondary storage device, and the like and operates an application. The operating system 602 includes at least the accelerator driver 610 and an HDD/SSD driver 611 therein.

The accelerator driver 610 is software which is used when the application 601 uses the accelerator 114. The accelerator driver 610 has functions of an accelerator DRAM allocator 621, off-load command submit 622, off-load command completion check 623, and accelerator management information acquisition 624.

The accelerator DRAM allocator 621 is a function of managing a storage area of the DRAM 401 included in the accelerator 114. The application 601 notifies the accelerator DRAM allocator 621 of a memory request and a memory request size during the use of the accelerator 114.

The notified accelerator DRAM allocator 621 retrieves an empty region in the storage area to be managed of the DRAM 401 within the accelerator 114, and secures the region corresponding to a request size. The accelerator DRAM allocator 621 records information indicating that the secured region is being used, in the accelerator management information 800 managed by the accelerator DRAM allocator 621. The accelerator DRAM allocator 621 returns a physical address indicating the head of the secured region to the application 601. On the other hand, in a case where the storage area of the DRAM 401 which corresponds to the request size cannot be secured, the accelerator DRAM allocator 621 notifies the application 601 of information indicating that the storage area corresponding to the request size cannot be secured.

In addition, the off-load processing unit 606 of the application 601 instructs the accelerator DRAM allocator 621 to open a memory region in a case where the storage area of the DRAM 401 within the accelerator 114 being used becomes unnecessary (for example, when the acquisition of an off-load result of filtering processing is completed, and the like). The instructed accelerator DRAM allocator 621 changes a corresponding region from the internal management information (management information) to an “empty” state to perform updating. The accelerator DRAM allocator 621 notifies the off-load processing unit 606 of the application 601 that the opening of the memory region has been completed.

The off-load command submit 622 is a function which is used when the off-load processing unit 606 of the application 601 submits a predetermined off-load command to the accelerator 114. The off-load processing unit 606 of the application 601 instructs the HDD/SSD 115 to transmit target data to the storage area secured by the accelerator DRAM allocator 621. The application 601 gives the execution of processing and conditions of filtering processing to the off-load command submit 622 of the accelerator driver 610.

The off-load command submit 622 notifies the accelerator 114 of conditions of filtering processing to start execution. Thereafter, the off-load command submit 622 notifies the off-load processing unit 606 of the application 601 that the submission of the off-load command has been completed.

The off-load command completion check 623 is a function for inquiring of the accelerator 114 whether or not the off-load command submitted by the off-load processing unit 606 of the application 601 has been completed.

The accelerator driver 610 holds the completion of processing of the off-load command notified from the accelerator 114, and determines whether or not the designated off-load command has been completed, with reference to the accelerator management information 800 when access from the off-load processing unit 606 of the application 601 through the off-load command completion check 623 is made. The off-load command completion check 623 confirms the completion of the off-load command in the accelerator 114 and then transmits a response of a result of the filtering processing to the off-load processing unit 606 of the application 601.

The accelerator management information acquisition 624 is a function which is used for the load detection unit 605 and the off-load processing unit 606 of the application 601 to acquire the accelerator management information 800 to be described later. The application 601 of this example manages the plurality of accelerators 114 and performs adjustment so that a load to each accelerator 114 is leveled.

For this reason, the application 601 acquires management information of the accelerator 114 by using the function of the accelerator management information acquisition 624 before the submission of the off-load command, and selects the accelerator 114 presently having a relatively low load from the management information. This function makes the application 601 of this example realize the leveling of the load of the accelerator 114.

In this example, an example in which the application 601 directly communicates with each function of the accelerator driver 610 is described, but the invention is not limited to this example. For example, a library (or a function within the operating system 602) accessed by the plurality of applications 601 in common is present, and the library may arbitrate requests from the plurality of applications 601 to have access to the accelerator driver 610.

In addition, the function of the accelerator management information acquisition 624 may be software capable of being referred to by the plurality of application 601 operated on the operating system 602 instead of being referred to by the driver within the operating system 602.

The HDD/SSD driver 611 is software which is used when the application 601 submits an IO command to the HDD/SSD 115, and has functions of IO CMD1 submit 631, IO CMD2 submit 632, and IO CMD completion check 633.

The IO CMD1 submit 631 is a function which is used to acquire target data from the HDD/SSD 115 when the processing execution unit 607 of the application 601 performs data processing by using the processor 112. The application 601 processes data, and thus requests the operating system 602 to secure a storage area for storing target data. The securing of the storage area is a function such as “malloc” or “posix_memalign” when the operating system 602 is Linux, and the operating system 602 requested to secure the storage area secures the requested storage area from the empty region of the DRAM 111 under management to transmit a response of a virtual address of the storage area to the application 601.

Next, the application 601 notifies the IO CMD1 submit of the virtual address and instructs the virtual address to store target data. The IO CMD1 submit 631 having received the instruction inquires the virtual address to another function of the operating system 602, converts the virtual address into a physical address, and notifies the HDD/SSD 115 of the physical address to instruct the HDD/SSD 115 to acquire the target data.

In addition, the application 601 notifies the IO CMD1 submit of continuous virtual addresses, but may convert the virtual addresses into physical addresses to form a plurality of discrete physical addresses. In this case, the IO CMD1 notifies the HDD/SSD 115 of all of the plurality of discrete physical addresses. The notified HDD/SSD 115 transmits target data to the plurality of designated physical addresses. After the transmission of the target data is completed, the HDD/SSD 115 notifies the application 601 of the server 100 of transmission completion information.

The IO CMD2 submit 632 is a function which is used to transmit target data to the DRAM 401 within the accelerator 114 from the HDD/SSD 115 when the off-load processing unit 606 of the application 601 performs data processing by using the accelerator 114.

The off-load processing unit 606 of the application 601 performs data processing by the accelerator 114, and thus secures a storage area in the DRAM 401 within the accelerator 114 for storing target data by using the accelerator DRAM allocator 621 mentioned above. In this case, the accelerator DRAM allocator 621 returns a physical address of the DRAM 401 within the accelerator which indicates the secured storage area to the application 601.

The off-load processing unit 606 of the application 601 notifies the IO CMD2 submit 632 of the physical address of the DRAM 401 within the accelerator to instruct the IO CMD2 submit to transmit data. The instructed IO CMD2 submit 632 notifies the HDD/SSD 115 of the physical address notified from the application 601 to instruct the HDD/SSD to transmit target data.

The HDD/SSD 115 instructed to transmit data by the IO CMD2 submit 632 transmits the data to the physical address of the DRAM 401 within the designated accelerator, and notifies the off-load processing unit 606 of the application 601 in the server 100 of transmission completion information when the transmission is completed.

The IO CMD completion check 633 is a function for detecting the completion of a command submitted to the IO CMD1 or the IO CMD2 by the application 601. When the HDD/SSD driver 611 detects the completion of data transmission of the HDD/SSD 115, the HDD/SSD driver 611 records and holds information indicating the completion of data transmission in the internal management information (not shown).

The off-load processing unit 606 of the application 601 calls the IO CMD completion check 633 on a regular basis (at a predetermined cycle) to inquire of the HDD/SSD driver 611 whether or not the IO CMD being submitted has been completed. In this case, the HDD/SSD driver 611 notifies the off-load processing unit 606 of the application 601 of “completion of data transmission” or “incompletion of data transmission” with reference to the internal management information.

The operating system 602 and each functional unit of the application 601 are loaded to the DRAM 111, which serves as a memory, as programs.

The processor 112 is operated as a functional unit providing a predetermined function by performing processing in accordance with a program of each functional unit. For example, the processor 112 functions as a data processing unit (application 601) by performing processing in accordance with a database program. The same is true of other programs. Further, the processor 112 also functions as a functional unit providing a function of each of a plurality of processes executed by programs. A computer and a computer system are respectively a device and a system which include the functional units.

Information, such as programs and information, for realizing functions of the operating system 602 and the application 601 can be stored in a storage device such as a storage sub-system, a non-volatile semiconductor memory, a hard disk drive, or a Solid State Drive (SSD), or a non-transitory computer-readable data storage medium such as an IC card, an SD card, or a DVD.

FIG. 7 is a map illustrating an example of a memory space of the server 100. A memory space 1110 of the DRAM 111 of the server 100 is managed by the operating system 602. In the example illustrated in the drawing, virtual addresses allocated to the memory space 1110 of the DRAM 111 of the server 100 indicate examples of 0h to E0000h.

The operating system 602 allocates a physical address of the DRAM 401 of the accelerator 114 to the virtual address of the memory space 1110.

For example, the operating system 602 allocates 0h to FFFh which are physical addresses of the DRAM 401 of the accelerator 114-1 to A000h to AFFFh which are virtual addresses within the memory space 1110. In addition, the operating system 602 allocates, for example, 0h to FFFh which are physical addresses of the DRAM 401 of the accelerator 114-2 to D000h to DFFFh which are virtual addresses within the memory space 1110.

The accelerator 114 writes a processing result for target data off-loaded to the storage area (A000 to AFFF, D000 to DFFF) which is allocated to the DRAM 111. Thereby, the application 601 can use the result of the off-load processing which is written in the DRAM 111.

Meanwhile, in the above, an example in which the application 601 is executed on the operating system 602 has been described, but a case where the virtualization software 604 illustrated in FIG. 10 is used will be described as follows. FIG. 10 illustrates a modification example of this example, and is a block diagram illustrating an example of a software configuration of the server 100.

The virtualization software 604 is software for operating the guest operating system 602 by the operating system 602. The virtualization software is software that relays various commands given to the accelerator 114 and the HDD/SSD 115 from the guest operating system 602. The virtualization software 604 performs the securing of a storage area in the DRAM 401 within the accelerator 114, the submission of an off-load command, and the submission of various IOs on the accelerator driver 610 and the HDD/SSD driver 611 in the same form as the application 601.

The guest operating system 602 is an operating system which is operated on the virtualization software 604. The guest operating system 602 includes a driver 641 within guest operating system which has the same interface as those of the accelerator driver 610 and the HDD/SSD driver 611 within the operating system 602.

The application 601 operated on the guest operating system 602 notifies the accelerator driver 610 and the HDD/SSD driver 611 within the operating system 602 of a command by using the driver 641 within guest operating system.

The driver 641 within guest operating system provides the same interface as those of the accelerator driver 610 and the HDD/SSD driver 611 within the operating system 602 to the application 601. The driver 641 within guest operating system transmits an instruction to the accelerator driver 610 or the HDD/SSD driver 611 through the virtualization software 604 in accordance with an instruction given from the application 601.

(1-5) Accelerator Management Information

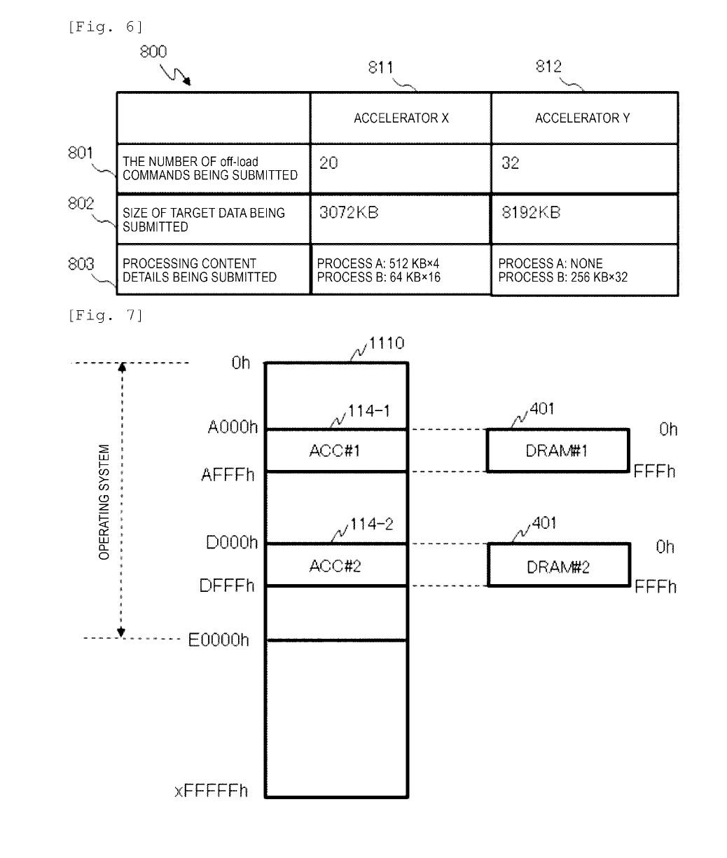

Next, the accelerator management information 800 will be described with reference to FIG. 6. FIG. 6 is a diagram illustrating an example of the accelerator management information 800 of the server 100.

The accelerator management information 800 is managed and updated by the accelerator driver 610 mentioned above. The accelerator driver 610 updates a corresponding item of the accelerator management information 800 whenever the accelerator driver submits an off-load command on the basis of an instruction given from the application 601.

The accelerator management information 800 of this example includes entries of the number of off-load commands being submitted 801, size of target data being submitted 802, and processing content details being submitted 803, and includes individual fields 811 and 812 which are independent for each accelerator 114. Meanwhile, in the drawing, an accelerator X corresponds to the accelerator 114-1, and an accelerator Y corresponds to the accelerator 114-2.

The number of off-load commands being submitted 801 is a field in which the number of off-load commands having been submitted to the corresponding accelerator 114 is stored. When the accelerator driver 610 notifies the accelerator 114 of the off-load command, the accelerator driver increments the field by the number of off-loaded commands to update the field.

In addition, when the accelerator driver 610 receives the completion of the off-load command from the accelerator 114, the accelerator driver increments values of the fields 811 and 812 of the number of off-load commands being submitted 801 to update the fields.

The application 601 can acquire the values of the fields 811 and 812 to acquire a difference in load between the accelerators 114. In a case where it is assumed that contents of the off-load commands submitted to the accelerators 114 by the plurality of applications 601 are the same as each other, the application 601 submits the off-load command to the accelerator 114 having relatively small values of the fields 811 and 812 to level the load of the accelerator 114.

In the example illustrated in FIG. 6, in the entry of the number of off-load commands being submitted 801, 20 commands are submitted to the accelerator X, and 32 commands are submitted to the accelerator Y. In a case where the off-load commands are the same as each other (processing contents are the same as each other and request sizes are the same as each other), the command is submitted to the accelerator 1 having small values of the fields to level a load.

In a case where the command is submitted to the accelerator 114-1, the accelerator driver 610 increments the values of the fields 811 and 812 from 20, which is the existing value, to 21 to update the fields. In a case where the completion of the command is received from the accelerator 114-1, the accelerator driver decrements the value of the field from 20 to 19 and stores the value.

The size of target data being submitted 802 is an entry in which the amount of target data having been submitted to the corresponding accelerator 114 is stored. When the accelerator driver 610 notifies the accelerator 114 of an off-load command, the accelerator driver increments the values of the fields 811 and 812 of this entry by the size of off-loaded data to update the fields.

In addition, when the accelerator driver 610 receives the completion of the off-load command from the accelerator 114, the accelerator driver decrements the values of the fields 811 and 812 of this entry to update the fields.

In an environment in which the size of target data to be off-loaded to the accelerator 114 has a large variation, it is not possible to predict the load of the accelerator 114 with values stored in the above-mentioned entry of the number of off-load commands being submitted 801. In this case, the load of the accelerator 114 is estimated using the values of the fields 811 and 812 in the entry of the size of target data being submitted 802. For example, in a case where the size of target data 802 of each command is small even in the accelerator 114 having a large number of commands being submitted, it is supposed that a time required for processing is short. For this reason, the application 601 can select the accelerator 114 having a relatively small value of the size of data being submitted 802 and perform off-load to level the load of the accelerator 114.

In the example illustrated in FIG. 6, an off-load command of a total of 3072 KB has been submitted to the accelerator X, and an off-load command of a total of 8192 KB has been submitted to the accelerator Y. When the off-loaded processing contents are the same type, it is possible to achieve the leveling of a load by submitting an off-load command to the accelerator 1 having relatively small values of the fields 811 and 812.

The processing content details being submitted 803 is an entry in which processing details of an off-load command having been submitted to the corresponding accelerator 114 are stored. In a case where the accelerator 114 can perform a plurality of processes, for example, in a case of the accelerator 114 capable of performing two types of processes of “data filtering” and “image data format conversion”, the application 601 have different processing times of processes, and thus it is not possible to estimate a processing time until completion by the accelerator 114 from the number of off-load commands being submitted 801 and the size of target data being submitted 802.

Consequently, a processing content and the size of data to be processed are stored for each command being submitted in the processing content details being submitted 803, and the application 601 estimates a processing time for each command as a load from the pieces of information. The application 601 performs off-loading to the accelerator 114 having a relatively short processing time to realize the leveling of the load of the accelerator 114. In a case where it is considered that processing by the processor 112 is performed at higher speed from the estimated processing time, the processing is performed by the processor 112.

In the example illustrated in FIG. 6, in the entry of the processing content details being submitted 803 of the accelerator X, information indicating that “four” commands for setting the size of data to be processed to “512 KB” are being submitted is stored in the field 811 for “a process A requiring a processing time of 100 μs for data processing for every 4 KB”.

Further, in the entry of the processing content details being submitted 803, information indicating that “16” commands for setting the size of data to be processed to “64 KB” are being submitted is stored in the field 811 for “a process B requiring a processing time of 10 μs for data processing for every 16 KB”.

In this case, the application 601 acquiring the information from the accelerator driver 610 predicts that a processing completion time of the accelerator Y is approximately 100 μs×512 KB/4 KB×4+10 μs×64 KB/16 KB×16=51200 μs+256 μs=53760 μs, from the acquired information.

The application 601 similarly performs calculation and comparison of the processing completion time with respect to the other accelerators 114 (the accelerator Y in the example illustrated in FIG. 6 has a value of 10 μs×256 KB/16 KB×32=5120 μs, and thus the accelerator X has a smaller size of target data 802), and selects the accelerator 114 having a relatively short processing completion time to perform leveling of the load of the accelerator 114. In addition, the application 601 can use the accelerator management information 800 as information for determining whether to perform the processing of target data by the processor 112 or whether to off-load the processing to the accelerator 114.

Meanwhile, in the above-described example, an example is described in which the accelerator management information 800 is held in the accelerator driver 610 of the operating system 602, but the accelerator management information may be held in the application 601.

(1-6) Data Processing Contents

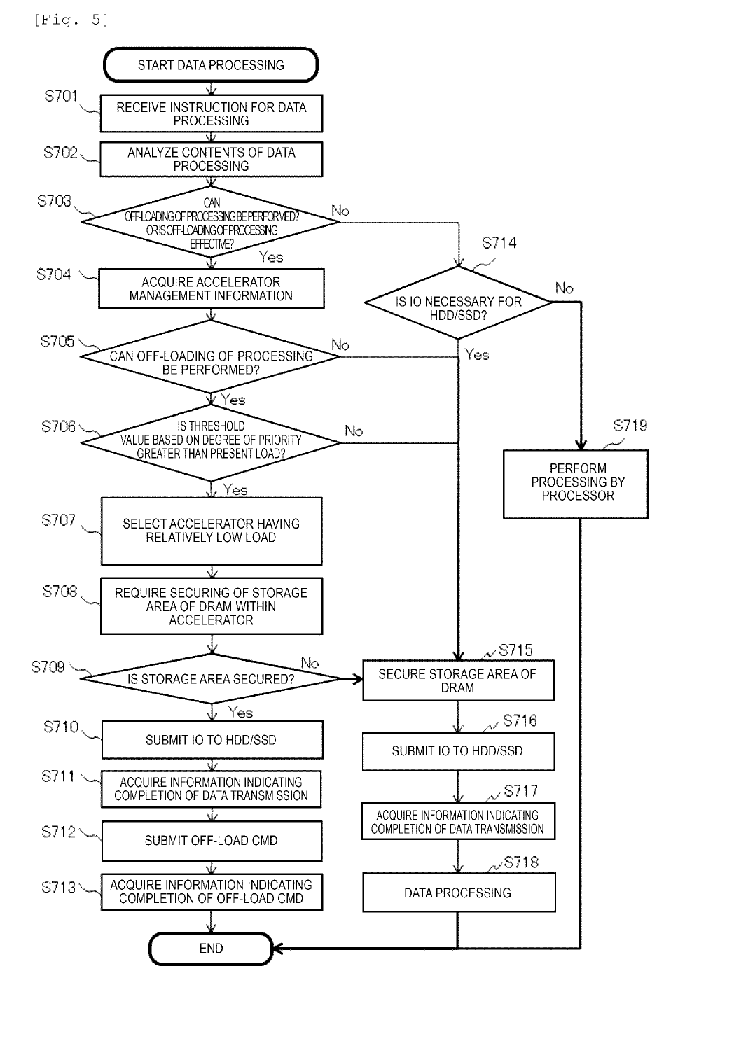

Subsequently, an example of processing performed by the server 100 of this example will be described with reference to FIG. 5. FIG. 5 is a flowchart illustrating an example of processing performed by the server 100. The flowchart is performed by an application 601 of a target database of this example. The application 601 operated as database software performs data processing in accordance with processing requests received from various clients of the server 100. When the application 601 receives the processing requests, the application executes the flowchart illustrated in FIG. 5. In addition, a main body performing processing in each step illustrated in FIG. 5 is the processor 112 that executes the application 601.

In the first step S701 of data processing in this example, the application 601 receives an instruction (or a request) for the data processing. For example, in a case where an instruction for creating an index in the entire database is notified from a client PC (not shown) connected to the server 100, the database which is the application 601 of this example receives the instruction.

In the next step S702, the application 601 analyzes a content of the instruction for the data processing which is received in step S701. In this step, the received data processing is divided into a plurality of types of internal processing by the application 601. For example, in a case where the content of the instruction for the received data processing is an instruction for creating an index, the received data processing is divided into filtering processing for acquiring data corresponding to a condition designated for the creation of an index and processing for generating management information of the index on the basis of a result of the filtering processing.

In step S703, it is determined whether or not the off-loading of processing can be performed by the accelerator 114 or whether or not the off-loading is effective, for each of the plurality of processing performed in step S702. For example, in a case where it is determined in step S702 that two types of processing of “filtering processing” and “index management information generation” are necessary, it is determined whether the off-loading of processing can be performed by the accelerator 114 for each processing of “filtering processing” and “index management information generation”.

The accelerator 114 of this example is equipped with, for example, only a function of “filtering processing”. In the above-described example, the application 601 determines that the off-loading of processing can be performed by the accelerator 114 for “filtering processing” out of the two processing, and proceeds to step S704.

On the other hand, the application 601 determines that the off-loading of processing to the accelerator 114 cannot be performed for “index management information generation”, and proceeds to step S714.

In addition, the application 601 determines that the off-loading to the accelerator 114 is not effective for a reduction in a processing time, in a case where a processing time when processing is performed by the processor 112 is estimated to be approximately 5 μs and a processing time based on the submission of an off-load command and the accelerator 114 is estimated to be 10 μs, for example, when the size of data capable of being off-loaded by one submission of an off-load command is equal to or smaller than a predetermined threshold value Th1, even though processing can be off-loaded to the accelerator 114, and proceeds to step S714.

On the other hand, the application 601 proceeds to step S704 in a case where the size of data capable of being off-loaded to the accelerator 114 exceeds the threshold value Th1 by one submission of an off-load command.

In this example, an example is described in which the application 601 predicts a processing time from the size of data processed by one submission of an off-load command to perform processing by division into a case where the processing is performed by the processor 112 and a case where the processing is performed by the accelerator 114, but the invention is not limited to this example.

For example, the application 601 may manage a lower limit of a request (data size) for performing off-loading to the accelerator 114 as a fixed value. For example, the application 601 may hold the threshold value Th1 for processing data of 16 KB or less by the processor 112 and may determine whether or not off-loading can be performed in accordance with the threshold value Th1.

In step S704, the application 601 acquires use conditions of the accelerator 114 from the accelerator driver 610. The application 601 acquires the accelerator management information 800 by using the accelerator management information acquisition 624 of the accelerator driver 610.

In step S705, the application 601 determines whether or not processing can be off-loaded to the accelerator 114 by using the accelerator management information 800 acquired in step S704. The application 601 estimates the load of each accelerator 114 as described above with reference to the accelerator management information 800 acquired from the accelerator driver 610, and determines whether or not the off-loading can be performed in accordance with a result of comparison between the processing time of the accelerator 114 and the processing time of the processor 112.

For example, the application 601 prohibits the off-loading of processing to the accelerator 114 in a case where all of the accelerators 114 have a high load and it is determined that a processing waiting time when the processing is executed by the accelerator 114 is longer than a time for which the processing is executed by the processor 112, and proceeds to step S714. In other words, in a case where an increase in the performance of the processing based on the accelerator 114 cannot be expected, the off-loading of the processing is not performed. Meanwhile, the processing waiting time when performing the off-loading to the accelerator 114 includes a time until the creation of a command and the reception of a result of the off-loading. In addition, calculation of the processing waiting time of the accelerator 114 and the processing time of the processor 112 will be described later.

On the other hand, in a case where the processing waiting time when performing the processing by the accelerator 114 is shorter than the time when performing the processing by the processor 112, the application 601 determines that an effect of increasing performance based on the off-loading of processing to the accelerator 114 can be expected, and proceeds to step S706.

Step S706 is a step in which the application 601 determines the use of the accelerator 114 by using the degree of priority which is given to the application 601 in advance.

When the operating system 602 is Linux or Unix as a standard for determination regarding whether or not the off-loading can be executed, the application 601 of this example performs the determination by using a nice value given to the application 601. For example, the application 601 determines whether or not the sum of loads of the accelerators 114 connected to the server 100 exceeds the threshold value Th2 determined to be the nice value=5.

When the sum of loads of the accelerators 114 exceeds the threshold value Th2, the application 601 set to be “nice value=5” causes another application 601 having a relatively high degree of priority (nice value is smaller than 5) to preferentially use the accelerator 114 and thus abandons the use of the accelerator 114, and proceeds to step S715.

On the other hand, in a case where the nice value of the application 601 is small (the degree of priority is high) and the sum of loads of the plurality of accelerators 114 is less than the threshold value Th2 of the nice value, the application 601 proceeds to step S707 in order to use the accelerator 114.

In this example, an example is described in which a nice value which is a priority degree setting value of the application 601 used in the UNIX system is used as a degree of priority of the application 601, but the invention is not limited to this example. A value representing a degree of priority of a system completely different from the nice value may be used. For example, a value for determining a degree of priority for the exclusive use of accelerators may be given as a parameter or a setting file from an input device (not shown) of the server 100 during the start-up of the application 601.

Next, in step S707, the application 601 determines that data processing is off-loaded to the accelerator 114 in step S706, and selects the accelerator 114 having a relatively low load. The application 601 selects the accelerator 114 having a relatively low load among the plurality of accelerators 114 connected thereto, with reference to the fields of the accelerator management information 800 acquired in step S704. By this processing, the loads of the accelerators 114 within the same computer system are leveled.

In step S708, the application 601 secures a storage area of the DRAM 401 in the accelerator 114 selected by the application 601 in step S707.

The application 601 notifies the accelerator DRAM allocator 621 within the accelerator driver 610 of the size of a region necessary for off-load processing, and instructs the DRAM 401 within the accelerator 114 to secure a storage area. The accelerator DRAM allocator 621 having received the instruction from the application 601 determines whether or not the size requested from the application 601 can be secured in the DRAM 401, with reference to management information (not shown) which is managed by the accelerator DRAM allocator 621.

In a case where the storage area can be secured, the accelerator DRAM allocator 621 notifies the application 601 of the secured region of the DRAM 401 within the accelerator 114. On the other hand, in a case where the storage area cannot be secured by the accelerator 114, the accelerator DRAM allocator 621 notifies the application 601 of information indicating that the storage area cannot be secured.

In step S709, the application 601 determines a result of the securing of the storage area of the DRAM 401 within the accelerator 114 which is acquired from the accelerator DRAM allocator 621.

In a case where the storage area of the DRAM 401 cannot be secured by the accelerator 114 in step S708, the application 601 transmits target data to the secured storage area of the DRAM 401 within the accelerator 114 and thus proceeds to step S710.

On the other hand, in a case where the storage area cannot be secured in the DRAM 401, it is difficult for the application 601 to off-load the processing to the accelerator 114, and thus the application 601 determines to perform the processing by the processor 112. Meanwhile, the application 601 does not notify a client, having made a request for processing, of an error in which the storage area cannot be secured in the DRAM 401. It is possible to realize smooth data processing with a little burden to the client by prohibiting the notification of the error. The application 601 transmits the target data to the DRAM 111 connected to the processor 112, and thus proceeds to step S715 to secure the storage area of the DRAM 111.

In step S710 for performing off-loading, the application 601 submits an IO command to the HDD/SSD 115 so as to transmit the target data to the storage area of the DRAM 401 within the accelerator 114 which is secured by the application 601 instep S708.

The application 601 notifies the IO CMD2 submit 632 within the HDD/SSD driver 611 of a physical address indicating the storage area of the DRAM 401 within the accelerator 114, which is acquired from the accelerator DRAM allocator 621 in step S708, and a region on the HDD/SSD 115 in which the size of data and the target data are stored.

The notified IO CMD2 submit 632 notifies the HDD/SSD 115 of various information received from the application 601 to start data transmission. In this case, the application 601 notifies the IO CMD2 submit 632 of the physical address, and thus does not need to convert the address acquired from the application 601 as in a case of the IO CMD1 submit 631 mentioned above.

Next, step S711 is a step in which the application 601 acquires the completion of data transmission from the HDD/SSD 115. The HDD/SSD driver 611 detects the completion of data transmission of the HDD/SSD with interruption from the HDD/SSD or polling.

The application 601 calls the IO CMD completion check 633 within the HDD/SSD driver 611 on a regular basis to monitor the HDD/SSD driver 611 detecting the completion of data transmission of the HDD/SSD 115. By such a regular monitoring of the application 601, the application 601 detects the completion of data transmission of the HDD/SSD 115.

In step S712, the application 601 having detected that the transmission of target data to the DRAM 401 within accelerator 114 in step S711 submits an off-load command to the accelerator 114.

The application 601 notifies the off-load command submit 622 within the accelerator driver 610 of information for designating target data to be processed. In this example, conditions of data desired to be acquired in filtering processing are notified in order to off-load the filtering processing to the accelerator 114.

In addition, the application 601 also notifies the off-load command submit 622 of the storage area of the DRAM 111 that stores results of the data processing performed by the accelerator 114. Meanwhile, the storage area is as illustrated in FIG. 7.

The notified off-load command submit 622 notifies the accelerator 114 of the storage area of the DRAM 111 that stores the conditions and results of the data processing, and instructs the accelerator to start the data processing.

The integrated processor 412 within the accelerator 114 having received the instruction starts up the data processing functional unit 414. In this case, the integrated processor 412 also notifies the data processing functional unit 414 of the storage area of the DRAM 111 which is notified from the application 601, as a region in which the results of the data processing are stored. The started-up data processing functional unit 414 acquires target data from the DRAM 401 within the accelerator 114, performs data processing, and transmits results of the processing to the notified storage area of the DRAM 111.

After the off-load processing is completed, the integrated processor 412 transmits a notice indicating the completion of the off-load command to the operating system 602. The accelerator driver 610 having received the completion of the off-load command from the integrated processor 412 records information indicating the completion of the off-load command in the accelerator management information 800.

Next, in step S713, the application 601 acquires a notice indicating the completion of the off-load command from the accelerator 114. In this example, when the accelerator driver 610 receives the notice indicating the completion of the off-load command from the integrated processor 412, the accelerator driver records information indicating the completion of the off-load command in internal management information (not shown).

The application 601 calls the off-load command completion check 623 within the accelerator driver 610 on a regular basis, and monitors a notice indicating the completion of the off-load command. In this case, the off-load command completion check 623 notifies the application 601 of “completion of off-load command” or “incompletion of off-load command” with reference to the internal management information (not shown) of the accelerator driver 610.

The application 601 receives the notice of “completion of off-load command” by the off-load command completion check 623 to detect that the off-load command submitted to the accelerator 114 has been completed.

In step S714 in which it is determined in step S703 that the processing is performed by the processor 112, the application 601 determines whether or not it is necessary to acquire target data from the HDD/SSD 115. For example, in a case where processing for creating new management information on the basis of a result of the filtering processing is performed, it is not necessary to acquire the target data from the HDD/SSD 115, and thus the processing is terminated after the processing of the application 601 is performed by the processor 112 (S719). In addition, a description of the processing of the application 601 which is performed by the processor 112 will be omitted.

On the other hand, in a case where it is determined that it is necessary to acquire the target data from the HDD/SSD 115, the application 601 proceeds to step S715. Step S715 is a step which is performed in a case where the application 601 determines that the data processing is performed by the processor 112, from a plurality of conditions such as “processing performed by the accelerator is inefficient due to a small size of data to be off-loaded”, “the accelerator does not correspond to the off-loading of the processing”, “the load of the accelerator is high”, “the sum of loads of the accelerators of the computer system exceeds a threshold value determined on the basis of a degree of priority of the application 601”, and “DRAM within the accelerator cannot be secured”.

The application 601 needs to transmit the target data to the DRAM 111 connected to the processor 112 in order to perform the data processing by the processor 112. For this reason, the application 601 secures a storage area of the DRAM 111 which is managed by the operating system 602. In this case, a known or well-known operating system (for example, Windows or Linux) 602 transmits a response of a virtual address for having access to the secured storage area of the DRAM 111 to the application 601.

In step S716, the application 601 submits an IO to the HDD/SSD 115 so as to transmit the target data to the storage area of the DRAM 111 which is secured in step S715. The application 601 notifies the IO CMD1 submit 631 within the HDD/SSD driver 611 of a virtual address, indicating the storage area of the DRAM 111 which is acquired from the operating system 602 in step S715, and a region on the HDD/SSD 115 in which the size of data and the target data to be processed are stored.

The notified IO CMD1 submit 631 converts the virtual address, indicating the storage area of the DRAM 111 which is received from the application 601, into a plurality of physical addresses, notifies the HDD/SSD 115 of the physical addresses, and instructs the HDD/SSD to start data transmission.

In step S717, the application 601 acquires information indicating the completion of data transmission from the HDD/SSD 115. The HDD/SSD driver 611 detects the completion of data transmission of the HDD/SSD 115 with interruption from the HDD/SSD 115 or polling. The application 601 calls the IO CMD completion check 633 within the HDD/SSD driver 611 on a regular basis to monitor the HDD/SSD driver 611 detecting the completion of data transmission of the HDD/SSD 115. By such a regular monitoring of the application 601, the application 601 detects the completion of data transmission of the HDD/SSD 115.

In step S718, the processor 112 performs data processing on the target data transmitted to the DRAM 111 connected to the processor 112 by step S717.

A description has been given of the examples of various processing until the application 601 determines whether or not it is necessary to use the accelerator 114 from the contents of command processing and the conditions of the loads of the accelerators 114 and off-loads data processing to the accelerator 114 by the above-described processing.

The application 601 can select data processing which is effectively off-loaded to the accelerator 114, among plurality of data processing, and can off-load the data processing to the accelerator 114 by performing the processing illustrated in the above-described flowchart. In a case where the load of the accelerator 114 is high, it is also possible to replace the processing with the processing by the processor 112 by stopping using the accelerator 114. In addition, the application 601 required to have high performance is given a high degree of priority, and thus the application 601 can preferentially use the accelerator 114.

Next, calculation of the processing waiting time of the accelerator 114 and the processing time of the processor 112 will be described below. First, the calculation of the processing time of the processor 112 will be described.

The application 601 of this example individually manages a processing time of the processor 112 per predetermined unit data amount, for each processing content. The application 601 performs management such as “a processing time of a process A for data of 256 MB is 5 seconds” and “a processing time of a process B for data of 256 MB is 7 seconds”. When the process B for data of 1024 MB occurs, the application 601 calculates a processing time of the processor 112 from a processing time per unit data amount of the process B, as 1024 MB/256 MB×7 minutes=28 seconds.

Next, a processing waiting time of an accelerator will be described. The application 601 of this example individually manages a processing time of the accelerator 114 per predetermined unit data amount, for each processing content.

The application 601 performs management such as “a processing time of a process A for data of 256 MB is 0.3 seconds” and “a processing time of a process B for data of 256 MB is 0.6 seconds”. The application 601 acquires processing having been submitted to the accelerator 114 from the accelerator management information 800.

The application 601 acquires contents of submitted processing such as “five processes B for data of 1024 MB and two processes A for data of 2048 MB”. A processing waiting time of the accelerator 114 is the sum of a total processing time of these processes and processing which is newly submitted. In a case of the above-described example, 1024 MB/256 MB×0.6 seconds×5+2048 MB/256 MB×0.3 seconds×2=12 seconds+4.8 seconds=16.8 seconds is a time until the processing having already been submitted is completed. In a case where the accelerator 114 is caused to further perform the process B for data of 1024 MB in this state, processing of 1024 MB/256 MB×0.6 seconds=2.4 seconds is added.

As a result, a processing waiting time of the accelerator 114 is calculated as 16.8 seconds+2.4 seconds=19.2 seconds. The application 601 can compare the calculated value with the above-described processing time of the processor 112 to determine by which of the processor 112 and the accelerator 114 the processing can be performed at higher speed.

In addition, the processor 112 does not perform only the processing in the application 601, and thus may not equally compare the processing time of the processor 112 and the processing waiting time of the accelerator 114 with each other in comparison between processing times.

For example, the application 601 may cause the processing to be performed by the processor 112 only in a case where twice the processing time of the processor 112 exceeds the processing waiting time of the accelerator 114. In addition, a coefficient (twice in the previous example) which is multiplied by the processing time of the processor 112 may be determined from the proportion of the processing to the entire processing load of the system.

As described above, according to this example, in the computer system including the processor 112 and the accelerator 114, which are capable of executing data processing, it is possible to efficiently use the processor 112 and the accelerator 114 for different purposes in accordance with contents of the processing, a processing time, and a load of processing. For example, in a case where the size of target data is small and equal to or less than a threshold value Th1, an off-load command is generated by the processor 112, the accelerator 114 is caused to execute the off-load command, and a processing waiting time until the accelerator 114 completes the output of a processing result is longer than a processing time of the processor 112. In this case, in the server 100, it is possible to process data at high speed by causing the processor 112 to execute the processing without off-loading the processing to the accelerator 114.

In this case, the operating system 602 secures a storage area in the DRAM 111 connected to the processor 112 and transmits data to be processed from the HDD/SSD 115, and thus it is possible to perform the processing by the processor 112 at high speed.

On the other hand, in a case where the size of the target data is large and exceeds the threshold value Th1, the processing is completed in a shorter period of time when being off-loaded to the accelerator 114 than being performed by the processor 112. Therefore, the processor 112 can process a large amount of data at high speed by generating an off-load command and causing the accelerator 114 to execute the off-load command. In this manner, it is possible to realize data processing which is more efficient than that in the related art by changing over a device (the processor 112 or the accelerator 114) which executes processing in accordance with a processing time (processing cost).

In this case, the operating system 602 secures a storage area in the DRAM 401 within the accelerator 114 and transmits data to be processed from the HDD/SSD 115, and thus it is possible to perform processing by the accelerator 114 at high speed.

Further, the application 601 calculates the load of the accelerator 114 and off-loads processing to the accelerator 114 having a relatively low load. Thereby, it is possible to level loads of the plurality of accelerators 114.

In a case where the loads of the plurality of accelerators 114 are high on the whole (the sum of the loads exceeds a threshold value Th2), the use of the accelerator 114 is permitted for the application 601 only in a case where a degree of priority set for each application 601 exceeds the threshold value Th2, and thus it is possible to suppress an excessive increase in the load of the accelerator 114.

In a case where a storage area of the DRAM 401 cannot be secured by the accelerator 114, the application 601 executes processing by the processor 112, and thus it is possible to reliably realize data processing.

In addition, the application 601 off-loads only processing capable of being executed by the accelerator 114 and performs the other processing by the processor 112, and thus it is possible to suppress an increase in cost of the accelerator 114.

Meanwhile, in the above-described example, an example is described in which the application 601 determines an off-load destination of processing and whether or not off-loading is performed, but the operating system 602 may determine an off-load destination of processing and whether or not off-loading is performed.

Meanwhile, the invention is not limited to the above-described example, and includes various modification examples. For example, the above-described example has been described in detail in order to facilitate the understanding of the invention, and does not necessarily include all of the components described above. In addition, a portion of the components of a certain example can be replaced by the components of another example, and the components of a certain example can also be added to the components of another example. In addition, the addition, deletion, or replacement of other components can be applied to a portion of the components of each example independently or in combination.

In addition, a portion or all of the above-described components, functions, processing units, processing means, and the like may be realized by hardware, for example, by making a design of an integrated circuit. In addition, the above-described components, functions, and the like may be realized by software by a processor analyzing a program for realizing and executing each of the functions. Information such as a program for realizing each function, a table, and a file can be stored in a storage device such as a memory, a hard disk, or a Solid State Drive (SSD), or a storage medium such as an IC card, an SD card, or a DVD.

In addition, a control line and an information line which are considered to be necessary for description are shown, and all control lines and information lines of a product are not necessarily shown. It may be considered that almost all components are actually connected to each other.

1. A computer system that operates a data processing unit, the computer system comprising:
a processor;
a first memory which is connected to the processor;
an accelerator which includes a second memory; and
a storage device which is connected to the processor and the accelerator to store data,
wherein the data processing unit includes
a processing request reception unit which receives a processing request for the data,
a processing content analysis unit which analyzes contents of processing included in the processing request,
a load detection unit which detects a load of the accelerator,
an off-load processing unit which acquires analysis results of the contents of the processing and the load of the accelerator to make the accelerator execute the received processing when a predetermined condition is established, and
a processing execution unit which makes the processor execute the received processing when the predetermined condition is not established,
wherein the off-load processing unit makes the accelerator secure a storage area in the second memory, makes the storage device transmit the data included in the processing request to the storage area of the second memory, and makes the accelerator execute the processing, and
wherein the processing execution unit makes the processor secure a storage area in the first memory, makes the storage device transmit the data included in the processing request to the storage area of the first memory, and makes the processor execute the processing.

2. The computer system according to claim 1,
wherein the number of accelerators is two or more,
wherein the load detection unit acquires at least one of the number of commands being executed by the accelerator, processing contents, and the amount of data to calculate a load of each of the accelerators, and
wherein the off-load processing unit selects an accelerator having a relatively low load, among the accelerators, and makes the selected accelerator execute the processing.

3. The computer system according to claim 1,
wherein a plurality of the data processing units are operated, and a degree of priority is set in the data processing unit in advance, and
wherein the off-load processing unit makes the accelerator execute the processing when the degree of priority which is set in the data processing unit satisfies the predetermined condition.

4. The computer system according to claim 3,
wherein the degree of priority is set in the data processing unit during start-up of the data processing unit.

5. The computer system according to claim 1,
wherein the off-load processing unit prohibits the processing of the accelerator in a case where the accelerator is not capable of securing a storage area in the second memory, to make the processing execution unit execute the processing.

6. The computer system according to claim 1,
wherein the off-load processing unit determines that the predetermined condition is established when a size of the data to be processed exceeds a predetermined threshold value from the contents of the processing, and makes the accelerator execute the processing, and
wherein the processing execution unit determines that the predetermined condition is not established when the size of the data to be processed is equal to or less than the predetermined threshold value from the contents of the processing, and makes the processor execute the processing.

7. The computer system according to claim 1,
wherein the data processing unit allocates a physical address of the second memory of the accelerator to a virtual address of the first memory,
wherein the off-load processing unit notifies the storage device of the physical address of the second memory to transmit the data when the accelerator is made to execute the processing, and
wherein the processing execution unit converts the virtual address of the first memory into the physical address of first memory and notifies the storage device of the physical address to transmit the data when the processor is made to execute the processing.

8. The computer system according to claim 1,
wherein the data processing unit includes accelerator management information that holds the number of commands being executed by the accelerator, the processing contents, and the amount of data, as load information of the accelerator.

9. A method of controlling a computer that executes data processing and includes a processor, a first memory connected to the processor, an accelerator including a second memory, and a storage device connected to the processor and the accelerator to store data, the method comprising:
a first step of causing the computer to receive a processing request for the data;
a second step of causing the computer to analyze contents of processing included in the processing request;
a third step of causing the computer to detect a load of the accelerator;
a fourth step of causing the computer to acquire analysis results of the contents of the processing and the load of the accelerator to make the accelerator execute the received processing when a predetermined condition is established; and
a fifth step of causing the computer to make the processor execute the received processing when the predetermined condition is not established,
wherein the fourth step includes making the accelerator secure a storage area in the second memory, making the storage device transmit the data included in the processing request to the storage area of the second memory, and making the accelerator execute the processing, and
wherein the fifth step includes making the processor secure a storage area in the first memory, making the storage device transmit the data included in the processing request to the storage area of the first memory, and making the processor execute the processing.

10. The method of controlling a computer according to claim 9,
wherein the number of accelerators is two or more,
wherein the third step includes acquiring at least one of the number of commands being executed by the accelerator, processing contents, and the amount of data to calculate a load of each of the accelerators, and
wherein the fourth step includes selecting an accelerator having a relatively low load, among the accelerators, and making the selected accelerator execute the processing.

11. The method of controlling a computer according to claim 9,
wherein the computer executes data processing, and a degree of priority is set for the data processing in advance, and
wherein the fourth step includes making the accelerator execute the processing when the degree of priority which is set for the data processing satisfies the predetermined condition.

12. The method of controlling a computer according to claim 11,
wherein the degree of priority is set for the data processing during start-up of the data processing.

13. The method of controlling a computer according to claim 9,
wherein the fourth step includes prohibiting the processing of the accelerator in a case where the accelerator is not capable of securing a storage area in the second memory, and
wherein the fifth step includes making the processor execute the processing in a case where the accelerator is not capable of securing a storage area in the second memory.

14. The method of controlling a computer according to claim 9,
wherein the fourth step includes determining that the predetermined condition is established when a size of the data to be processed exceeds a predetermined threshold value from the contents of the processing, and making the accelerator execute the processing, and
wherein the fifth step includes determining that the predetermined condition is not established when the size of the data to be processed is equal to or less than the predetermined threshold value from the contents of the processing, and making the processor execute the processing.

15. The method of controlling a computer according to claim 9,
wherein the data processing includes allocating a physical address of the second memory of the accelerator to a virtual address of the first memory,
wherein the fourth step includes notifying the storage device of the physical address of the second memory to transmit the data when the accelerator is made to execute the processing, and
wherein the fifth step includes converting the virtual address of the first memory into the physical address of first memory and notifying the storage device of the physical address to transmit the data when the processor is made to execute the processing.
